(19) United States
(12) Patent Application Publication
(10) Pub. No.: US 2021/0025712 A1
(43) Pub. Date: Jan. 28, 2021

(54) METHOD FOR CORRECTING GYROSCOPE DATA OF MOBILE ROBOT, DEVICE, AND STORAGE MEDIUM

(71) Applicant: GUANGZHOU COAYU ROBOT CO., LTD., Guangzhou (CN)

(72) Inventors: Xingzhi WANG, Guangzhou (CN); Huang DING, Guangzhou (CN); Lilei WANG, Guangzhou (CN); Kai YANG, Guangzhou (CN); Zhuobin ZHENG, Guangzhou (CN)

(21) Appl. No.: 17/037,624

(22) Filed: Sep. 29, 2020

Related U.S. Application Data
(63) Continuation of application No. PCT/CN2019/077000, filed on Mar. 5, 2019.

(30) Foreign Application Priority Data
Apr. 26, 2018 (CN) 201810386307.8

(51) Int. Cl. G01C 21/16; G01S 17/86

(52) U.S. Cl. CPC G01C 21/1652; G01S 17/86

(57) ABSTRACT

The present disclosure provides a mobile robot gyroscope data correction method, device, and apparatus. The method includes obtaining laser radar data of a current frame, wherein a loop closure detection of the laser radar data of the current frame is successful; using an iterative closest point (ICP) algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot; determining a quantized value of each of the Y candidate estimated poses of the current frame according to the laser radar point set of each of the Y key frames and the laser radar point set of the current frame, wherein there is a maximum quantized value among the Y quantized values; and correcting the gyroscope data of the mobile robot according to the candidate estimated pose information corresponding to the maximum quantized value among the Y quantized values.

### CROSS-REFERENCE TO RELATED APPLICATIONS

This application is continuation of International Application No. PCT/CN2019/077000, filed on Mar. 5, 2019, which claims the benefit of priority to Chinese Patent Application No. 201810386307.8, filed on Apr. 26, 2018, both of which are hereby incorporated by reference in their entireties.

### BACKGROUND

The present disclosure relates to the field of communication, in particular to a mobile robot gyroscope data correction method, device, and apparatus.

With the continuous development of intelligent products, people's demand for intelligent home products has greatly increased. Intelligent cleaning robot has gradually entered our life. With certain artificial intelligence, it can automatically complete the ground cleaning work in the room, greatly facilitating people's lives.

In traditional technology, after loop closure detection, the mobile robot performs global optimization operation on all the key frame data recorded by the mobile robot's radar sensor, so as to obtain the optimized mobile robot's pose information in the current frame, and then correct the gyroscope data of the mobile robot according to the pose information in the current frame, so as to eliminate the interference of accumulated error on data correction of the gyroscope.

However, the global optimization operation in the existing technology has a large amount of calculation and a long calculation time, which leads to the poor real-time performance of mobile robot gyroscope data correction.

### SUMMARY

Based on this, it is necessary to provide a method, device, and apparatus for mobile robot gyroscope data correction, aiming at the problem of large amount of calculation and long calculation time in traditional technology of global optimization operation, which leads to poor real-time performance of mobile robot gyroscope data correction.

In a first aspect, an embodiment of the present disclosure provides a mobile robot gyroscope data correction method, including: performing loop closure detection of laser radar data of a current frame; if the loop closure detection is successful, using an iterative closest point ICP algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot; determining a quantized value of each candidate estimated pose of the current frame according to the laser radar point set of each key frame and the laser radar point set of the current frame; correcting the gyroscope data of the mobile robot according to the candidate estimated pose information corresponding to the maximum quantized value among the Y quantized values.

In one embodiment, using an iterative closest point ICP algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot, including: using the ICP algorithm to determine an initial estimated position of the current frame according to the laser radar point set of the key frame, the laser radar point set of the current frame and the initial estimated position of the key frame; determining an initial estimated angle of the current frame according to the laser radar point set of the key frame, the laser radar point set of the current frame, the initial estimated position of the key frame, the initial estimated angle of the key frame and the initial estimated position of the current frame; determining information of a candidate estimated pose of the current frame according to the initial estimated position of the current frame and the initial estimated angle of the current frame.

In one embodiment, using the ICP algorithm to determine an initial estimated position of the current frame according to the laser radar point set of the key frame, the laser radar point set of the current frame and the initial estimated position of the key frame, including: using the ICP algorithm to determine an estimated matrix according to the laser radar point set of the key frame and the laser radar point set of the current frame; the estimated matrix including a rotation matrix and a translation matrix; determining an initial estimated position of the current frame according to the estimated matrix and the initial estimated position of the key frame.

In one embodiment, determining an initial estimated angle of the current frame according to the laser radar point set of the key frame, the laser radar point set of the current frame, the initial estimated position of the key frame, the initial estimated angle of the key frame and the initial estimated position of the current frame, including: determining a laser radar data center point of the key frame according to the laser radar point set of the key frame; determining a laser radar data center point of the current frame according to the laser radar point set of the current frame; determining an initial estimated angle of the current frame according to the laser radar data center point of the key frame, the laser radar data center point of the current frame, the initial estimated position of the key frame, the initial estimated angle of the key frame and the initial estimated position of the current frame.

In one embodiment, determining a laser radar data center point of the key frame according to the laser radar point set of the key frame and determining a laser radar data center point of the current frame according to the laser radar point set of the current frame, including: determining a laser radar data center points p₀ in the key frame according to a formula

$${p}_{0} = \frac{1}{N} {\sum }_{i = 1}^{N} {P}_{i} ;$$

wherein, p₁ is any point in the laser radar point set of the key frame; determining a laser radar data center points q₀ in the current frame according to a formula

$${q}_{0} = \frac{1}{N} {\sum }_{i = 1}^{N} {q}_{i} ;$$

wherein, q₁ is any point in the laser radar point set of the current frame.

In one embodiment, determining a quantized value of each candidate estimated pose of the current frame according to the laser radar point set of each key frame and the laser radar point set of the current frame, including: performing rotation translation transformation operation on Y laser radar point sets of the key frames to obtain Y transformed laser radar point sets; determining a number of internal points and a number of external points in each of the transformed laser radar point sets according to each of the transformed laser radar point sets, the laser radar point set of the current frame and a first preset threshold; determining a quantized value of each candidate estimated pose of the current frame according to the number of internal points and the number of external points in each of the transformed laser radar point sets.

In one embodiment, determining a number of internal points and a number of external points in each of the transformed laser radar point sets according to each of the transformed laser radar point sets, the laser radar point set of the current frame and a first preset threshold, including: determining a third distance corresponding to each data point in the transformed laser radar point set according to the transformed laser radar point set and the laser radar point set of the current frame; the third distance being a minimum distance between data points in the transformed laser radar point set and data points in the laser radar point set of the current frame; determining a number of internal points and a number of external points in each of the transformed laser radar point sets according to the third distance and the first preset threshold.

In one embodiment, determining a number of internal points and a number of external points in each of the transformed laser radar point sets according to the third distance and the first preset threshold, including: if the third distance is less than the first preset threshold, determining that points in the transformed laser radar point set to be internal points; if the third distance is greater than three times of the first preset threshold, determining that points in the transformed laser radar point set to be external points; determining a number of internal points and a number of external points in each of the transformed laser radar point sets according to the internal points and external points in each of the transformed laser radar point sets.

In one embodiment, determining a quantized value of each candidate estimated pose of the current frame according to the number of internal points and the number of external points in each of the transformed laser radar point sets, including: according to a number of internal points and a number of external points in the i-th transformed laser radar point set, determining a ratio of the number of internal points to the number of external points corresponding to the i-th transformed laser radar point set; wherein, 1≤i≤Y; judging whether the ratio of the number of internal points to the number of external points corresponding to the i-th transformed laser radar point set is less than a second preset threshold to obtain a judgment result; determining a quantized value of the transformed laser radar point set according to the judgment result; determining a sum of quantized values of the Y transformed laser radar point sets as a quantized value of a j-th estimated pose of the current frame; wherein, 1≤j≤Y.

In one embodiment, determining a quantized value of the transformed laser radar point set according to the judgment result, including if the judgment result is that the ratio of the number of internal points to the number of external points corresponding to the i-th transformed laser radar point set is less than the second preset threshold, determining the ratio of the number of internal points to the external points corresponding to the i-th transformed laser radar point set as the quantized value of the transformed laser radar point set; and if the judgment result is that the ratio of the number of internal points to the number of external points corresponding to the i-th transformed laser radar point set is not less than the second preset threshold, determining the second preset threshold as the quantized value of the transformed laser radar point set.

In one embodiment, correcting the gyroscope data of the mobile robot according to the candidate estimated pose corresponding to the maximum quantized value among the Y quantized values, including if the maximum quantized value is greater than a third preset threshold, correcting the gyroscope data of the mobile robot according to the candidate estimated pose information corresponding to the maximum quantized value.

In one embodiment, correcting the gyroscope data of the mobile robot according to the candidate estimated pose information corresponding to the maximum quantized value, including determining a modified estimated angle of the current frame according to a laser radar data center point of a target key frame, an initial estimated position of the target key frame, an initial estimated angle of the target key frame, the laser radar data center point of the current frame, and the initial estimated position of the current frame; the target key frame being a key frame corresponding to the maximum quantized value; and correcting the gyroscope data of the mobile robot according to the modified estimated angle of the current frame and the candidate estimated pose information corresponding to the target key frame.

In a second aspect, an embodiment of the present disclosure provides a mobile robot gyroscope data correction device, including a loop closure detection module, being used to perform loop closure detection of laser radar data in a current frame; a first determination module, being used to, if the loop closure detection is successful, use an iterative closest point ICP algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot; a second determination module, being used to determine a quantized value of each candidate estimated pose of the current frame according to the laser radar point set of each key frame and the laser radar point set of the current frame; and a correction module, being used to correct the gyroscope data of the mobile robot according to the candidate estimated pose information corresponding to the maximum quantized value among the Y quantized values.

In a third aspect, an embodiment of the present disclosure provides an apparatus, including a memory and a processor, the memory storing a computer program that can be run on the processor, and the processor, when executing the computer program, realizing steps of a method of any of the above embodiments.

In a fourth aspect, an embodiment of the present disclosure provides a computer-readable storage medium where a computer program is stored. The computer program is configured to realize steps of a method of any of the above embodiments when the computer program is executed by the processor.

The gyroscope data correction method, device, and apparatus of the mobile robot provided by the present embodiment can enable the mobile robot to adopt ICP algorithm to determine information of Y candidate estimated poses of the current frame according to initial estimated positions of Y key frames, laser radar point sets of the Y key frames, initial estimation angles of the Y key frames, and the laser radar point set of the current frame of the mobile robot, determine a quantized value of each candidate estimated pose of the current frame according to the laser radar point set of each key frame and the laser radar point set of the current frame, and correct the gyroscope data of the mobile robot using the determined candidate estimated pose information corresponding to the maximum quantized value among the Y quantized values. Compared with the global optimization algorithm, the implementation of the ICP algorithm has the characteristics of simple steps and low algorithm complexity. Therefore, using the ICP algorithm to determine the Y estimated poses of the current frame can reduce the amount of calculation and shorten the calculation time, thus improving the real-time performance of gyroscope data correction. At the same time, correcting the gyroscope data of the mobile robot according to the estimated pose information corresponding to the maximum quantized value of Y quantized values is equivalent to selecting the best candidate estimated pose to correct the gyroscope data, which greatly improves the accuracy of the gyroscope data correction, thus, realizing quicker and more accurate gyroscope data correction, and improving the robustness of the system.

### BRIEF DESCRIPTION OF THE DRAWINGS

In order to more clearly explain the technical solution of the embodiment of the present disclosure, the following will be a brief introduction of the drawings to be used in the embodiment. It is obvious that the drawings in the following description are some embodiments of the present disclosure, and for a person having ordinary skill in the art, other drawings can also be obtained based on these drawings without involving inventive skills.

FIG. 1 is a system architecture diagram of an application of a mobile robot gyroscope data correction method provided by an embodiment of the present disclosure;

FIG. 2 is a flow diagram of a mobile robot gyroscope data correction method provided by an embodiment;

FIG. 3 is a flow diagram of a mobile robot gyroscope data correction method provided by an embodiment;

FIG. 4 is a flow diagram of a mobile robot gyroscope data correction method provided by an embodiment;

FIG. 5 is a flow diagram of a mobile robot gyroscope data correction method provided by an embodiment;

FIG. 6 is a flow diagram of a mobile robot gyroscope data correction method provided by an embodiment;

FIG. 7 is a flow diagram of a mobile robot gyroscope data correction method provided by an embodiment;

FIG. 8 is a flow diagram of a mobile robot gyroscope data correction method provided by an embodiment;

FIG. 9 is a flow diagram of a mobile robot gyroscope data correction method provided by an embodiment;

FIG. 10 is a structural diagram of a mobile robot gyroscope data correction device provided by an embodiment;

FIG. 11 is a structural diagram of a mobile robot gyroscope data correction device provided by an embodiment;

FIG. 12 is a structural diagram of a mobile robot gyroscope data correction device provided by an embodiment;

FIG. 13 is a structural diagram of a mobile robot gyroscope data correction device provided by an embodiment; and

FIG. 14 is a structural diagram of an apparatus provided by an embodiment.

### DETAILED DESCRIPTION

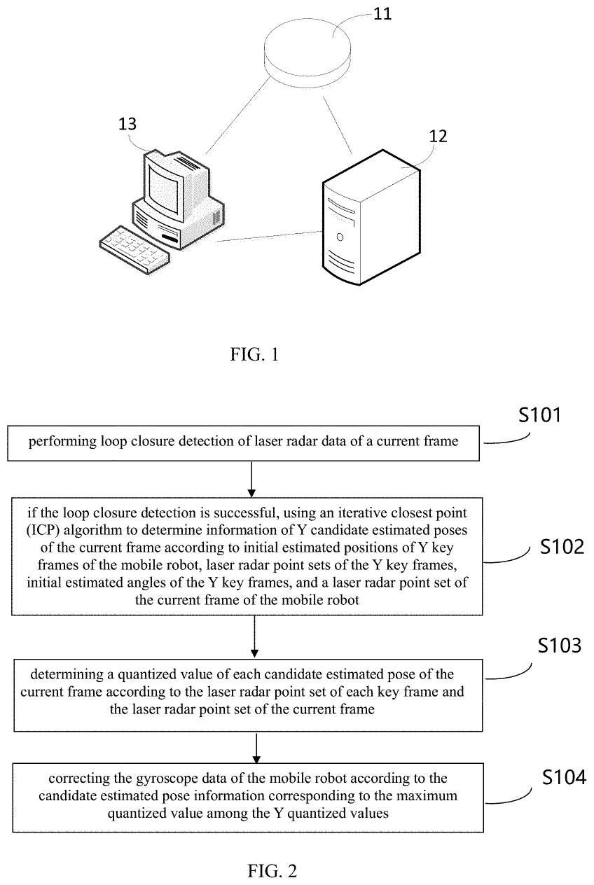

The mobile robot gyroscope data correction method provided by an embodiment of the present disclosure can be applied to a system shown in FIG. 1. As shown in FIG. 1, the system may include a robot 11, a server 12, and a terminal 13. Optionally, the robot 11 can be a cleaning robot or a mobile robot; Optionally, the server 12 can be a cloud server or a remote server; Optionally, the terminal 13 can be a mobile phone, a tablet computer, or a PDA (Personal Digital Assistant) and other intelligent terminals with any Internet access function. The present disclosure does not limit the specific types of terminals and servers.

In a traditional mobile robot, all the key frame data recorded by radar sensors are optimized globally to obtain the optimized pose of the mobile robot in the current frame. According to the pose in the current frame, the gyroscope data of the mobile robot is corrected. However, the global optimization operation in the data correction method has a large amount of calculation, and the calculation time is long. As a result, the real-time performance of gyroscope data correction by the mobile robot is poor. Therefore, the data correction method provided by the present disclosure aims to solve the technical problems existing in the above-mentioned traditional technology.

The mobile robot gyroscope data correction method provided by the embodiment of the present disclosure can not only realize fast estimation of the estimated pose of the current frame of the mobile robot, but also complete the faster correction of the gyroscope data, and improve the robustness and positioning accuracy of the mobile robot system. Therefore, the mobile robot provided by the embodiment of the present disclosure can not only be applied to trades such as industry, agriculture, medical treatment and service, but also be well applied in harmful and dangerous situations such as urban security, national defense and space exploration.

It should be noted that the execution subject of the following method embodiment can be any one of a mobile robot, a terminal and a server. The execution subject of the following method embodiment is illustrated with a robot as an example.

In order to make the purpose, technical solution and advantages of the present disclosure clearer, the technical solution in the embodiment of the present disclosure is further described in detail through the following embodiments and in combination with the attached drawings. It should be understood that the specific embodiments described herein are for the purpose of explaining the present disclosure only and are not intended to limit the present disclosure.

FIG. 2 is a flow diagram of a mobile robot gyroscope data correction method provided by an embodiment. This embodiment involves the specific process of a mobile robot adopting an iterative closest point algorithm to determine information of Y candidate estimated poses of a current frame according to initial estimated positions of Y key frames, laser radar point sets of the Y key frames, initial estimated angles of the Y key frames, and a laser radar point set of the current frame, determining a quantized value of each candidate estimated pose of the current frame, and correcting the gyroscope data of the mobile robot according to the candidate estimated pose information corresponding to the maximum quantized value. As shown in FIG. 2, the method includes:

S101, performing loop closure detection of laser radar data of a current frame.

Specifically, when the laser radar sensor obtains the laser radar data of the current frame, it detects whether there is laser radar data of the key frame matching with the laser radar data of the current frame.

S102, if the loop closure detection is successful, using an iterative closest point (ICP) algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot.

Specifically, the mobile robot obtains the laser radar point set of the current frame through laser radar sensors, and obtains X key frames matching with the laser radar point set of the current frame after the loop closure detection is successful, and randomly selects Y key frames from the X key frames. Since the laser radar point sets of these key frames are very similar to the laser radar point set of the current frame, information of Y candidate estimated poses of the current frame is determined according to the laser radar data information in the Y key frames.

Wherein, the initial position of the key frame is the initial position of the mobile robot determined by the data obtained by a laser radar sensor at the key frame time, the laser radar point set of the key frame is the set consisting of data points obtained by the laser radar sensor in the key frame, the initial estimated angle of the key frame is the angle information of the mobile robot determined by the data obtained by the laser radar sensor at the key frame time, the laser radar point set of the current frame of the mobile robot includes the set consisting of data points obtained by the laser radar sensor in the current frame, wherein, the duration of each frame of the laser radar sensor is the duration of one revolution of the laser radar sensor.

It should be noted that the mobile robot adopts the ICP algorithm to determine information of the Y candidate estimated poses of the current frame according to the initial estimated positions of the Y key frames, the laser radar point sets of the Y key frames, the initial estimated angles of the Y key frames, and the laser radar point set of the current frame of the mobile robot, but there are no restrictions on the implementation mode and process of the ICP algorithm.

Optionally, the laser radar point set can be a collection of laser radar data or a collection of visual image points.

S103, determining a quantized value of each candidate estimated pose of the current frame according to the laser radar point set of each key frame and the laser radar point set of the current frame.

Specifically, after the mobile robot has determined the information of Y candidate estimated poses of the current frame, it can determine the quantized value of each candidate estimated pose in the current frame according to the laser radar point set of each key frame and the laser radar point set of the current frame, and traverse the Y candidate estimated poses of the current frame to determine the corresponding quantized values of the Y candidate estimated poses.

For example, the quantized value of each candidate estimated pose can be determined according to a relative position between the data points in the laser radar point set of the key frame and the data points in the laser radar point set of the current frame. The closer the relative position is, the larger the quantized value is, and the farther the relative position is, the smaller the quantized value is.

S104, correcting the gyroscope data of the mobile robot according to the candidate estimated pose information corresponding to the maximum quantized value among the Y quantized values.

Specifically, Y quantized values can be sorted from large to small, and the first quantized value can be determined as the maximum quantized value; or, a bubble sorting method can be used to sort the Y quantized values to determine the maximum quantized value, and the gyroscope data of the mobile robot can be corrected according to the estimated pose information corresponding to the maximum quantized value.

According to the data correction method provided in this embodiment, the mobile robot performs loop closure detection on the laser radar data of the current frame. After the loop closure detection is successful, the ICP algorithm is used to determine the Y candidate estimated poses of the current frame according to the initial estimated positions of the Y key frames, the laser radar point set of the Y key frames, the initial estimated angles of the Y key frames, and the laser radar point set of the current frame of the mobile robot. According to the laser radar point set of each key frame and the laser radar point set of the current frame, the quantized value of each candidate estimated pose in the current frame is determined. The gyroscope data of the mobile robot is corrected according to the maximum quantized value of the determined Y quantized values. Compared with the global optimization algorithm, the implementation of the ICP algorithm has the characteristics of simple steps and low algorithm complexity. Therefore, using the ICP algorithm to determine the Y candidate estimated poses of the current frame can reduce the amount of calculation and shorten the calculation time, thus improving the real-time performance of gyroscope data correction. At the same time, correcting the gyroscope data of mobile robot according to the candidate estimated pose information corresponding to the maximum quantized value of the Y quantized values is equivalent to selecting the best candidate estimated pose to correct the gyroscope data, which greatly improves the accuracy of the gyroscope data correction, so that the gyroscope data can be corrected more quickly and accurately, and the robustness of the system is improved.

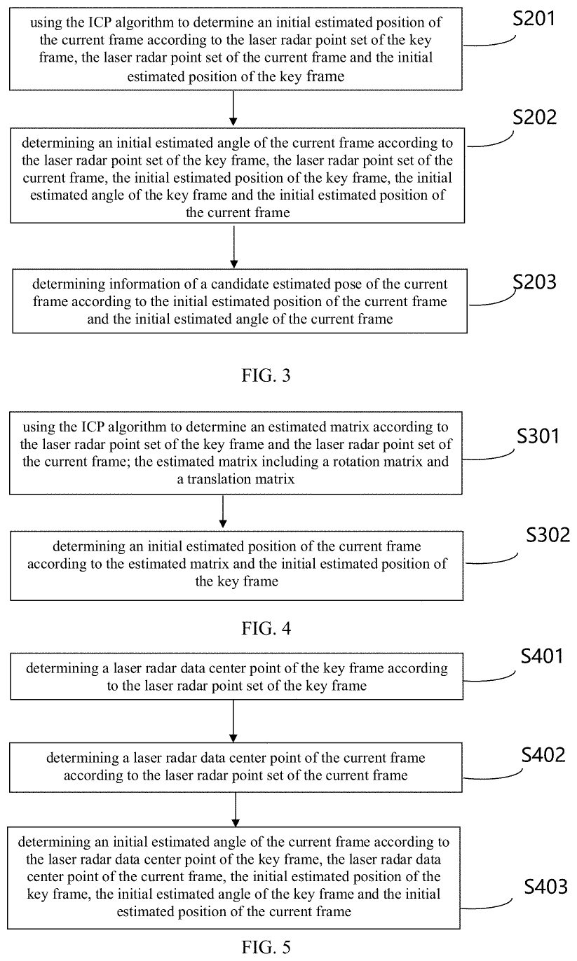

FIG. 3 is a flow diagram of a mobile robot gyroscope data correction method provided by an embodiment. This embodiment involves the specific process of using the ICP algorithm to determine information of Y candidate estimated poses of the current frame. Based on the above embodiment shown in FIG. 2, as shown in FIG. 3, an implementation mode of S102 may include S201, using the ICP algorithm to determine an initial estimated position of the current frame according to the laser radar point set of the key frame, the laser radar point set of the current frame and the initial estimated position of the key frame.

Specifically, the mobile robot obtains the laser radar point set of the current frame through the laser radar sensor, and obtains the laser radar point set of the key frame and the initial estimated position of the key frame after the loop closure detection is successful. Then the ICP algorithm is used to determine the initial estimated position of the current frame according to the laser radar point set of the key frame, the laser radar point set of the current frame and the initial estimated position of the key frame.

Optionally, as shown in FIG. 4, a possible implementation mode of S201 “using the ICP algorithm to determine an initial estimated position of the current frame according to the laser radar point set of the key frame, the laser radar point set of the current frame and the initial estimated position of the key frame” may include:

S301, using the ICP algorithm to determine an estimated matrix according to the laser radar point set of the key frame and the laser radar point set of the current frame; the estimated matrix including a rotation matrix and a translation matrix.

Specifically, an estimated matrix is determined using an ICP algorithm according to a laser radar point set of a key frame and a laser radar point set of a current frame; wherein, the estimated matrix includes a rotation matrix and a translation matrix.

Optionally, in this embodiment, the estimated matrix can be obtained by formula (Rᵢ,tᵢ)=ICP(KFᵢ,F), wherein, KFᵢ represents the laser radar point set of the key frame, F represents the laser radar point set of the current frame, Rᵢ is the rotation matrix and tᵢ is the translation matrix.

Optionally, the process of determining the rotation matrix Rᵢ and the translation matrix tᵢ is as follows: the data center point p₀ of the laser radar point set P of the key frame is obtained according to the formula

$${p}_{0} = \frac{1}{N} {\sum }_{i = 1}^{N} {P}_{i} ,$$

and the data center point q₀ of the laser radar point set q of the current frame is obtained according to the formula

$${q}_{0} = \frac{1}{N} {\sum }_{i = 1}^{N} {q}_{i} ,$$

and the distance Pᵢ′ between any point pᵢ in the laser radar point set P of the key frame and the laser radar data center point of the key frame is determined by the formula Pᵢ′=pᵢ−p₀, the distance qᵢ′ between any point qᵢ in the laser radar point set q of the current frame and the laser radar data center point of the current frame is determined by the formula qᵢ′=qᵢ−q₀, and some points are selected from the laser radar point set P of the key frame and the laser radar point set q of the current frame to participate the calculation of Rᵢ, for the i pair of point pairs, the corresponding matrix Aᵢ is calculated by the following formula:

$${A}_{i} = [ \begin{matrix}0 & {( {p}_{i}^{′} - {q}_{i}^{′} )}^{T} \\ {p}_{i}^{′} - {q}_{i}^{′} & {( {p}_{i}^{′} + {q}_{i}^{′} )}^{T}\end{matrix} ] .$$

Traversing all Aᵢ, the matrix B is calculated by formula

$$B = {\sum }_{i = 0}^{k} {A}_{i} {A}_{i}^{T} ,$$

and the minimum eigenvalue and eigenvector of B are calculated using singular value decomposition. The corresponding rotation matrix Rᵢ is obtained from the minimum eigenvector of B, and the translation matrix tᵢ is determined according to Rᵢ by the formula tᵢ=q₀−Rᵢp₀.

S302, determining an initial estimated position of the current frame according to the estimated matrix and the initial estimated position of the key frame.

Specifically, after determining the estimated matrix, the mobile robot determines the initial estimated position P_{Fi} of the current frame according to the estimated matrix and the initial position of the key frame.

Optionally, the initial estimated position P_{Fi} of the current frame can be determined by the formula P_{Fi}=RᵢP_{KFi}+tᵢ, where Rᵢ is the rotation matrix, tᵢ is the translation matrix, and P_{KFi} is the initial estimated position of the key frame.

The mobile robot gyroscope data correction method provided by the above embodiment uses ICP algorithm to determine an estimated matrix according to the laser radar point set of the key frame and the laser radar point set of the current frame, and determine an estimated position of the current frame according to the estimated matrix and an initial estimated position of the key frame. Due to the ICP algorithm, the estimation matrix can be quickly determined according to the laser radar point set of the key frame and the laser radar point set of the current frame. The algorithm has simple steps and fewer parameters and can quickly and accurately determine the initial estimation position of the current frame.

S202, determining an initial estimated angle of the current frame according to the laser radar point set of the key frame, the laser radar point set of the current frame, the initial estimated position of the key frame, the initial estimated angle of the key frame and the initial estimated position of the current frame.

Specifically, the mobile robot, after determining an initial estimated position of the current frame, then further determines an initial estimated angle of the current frame according to the laser radar point set of the key frame, the laser radar point set of the current frame, the initial estimated position of the key frame, and the initial estimated angle of the key frame.

Optionally, as shown in FIG. 5, a possible implementation mode of S202 may include S401, determining a laser radar data center point of the key frame according to the laser radar point set of the key frame.

Specifically, any point in the laser radar point set of the key frame can be selected as the laser radar data center point of the key frame; or, the laser radar data center point p₀ of the key frame can be determined according to the formula

$${p}_{0} = \frac{1}{N} {\sum }_{i = 1}^{N} {P}_{i} ;$$

where pᵢ is any point in the laser radar point set in the key frame; or, the laser radar center point in the key frame can be determined according to the geometric mean method, or the laser radar data center point in the key frame can also be determined according to the harmonic mean method.

S402, determining a laser radar data center point of the current frame according to the laser radar point set of the current frame.

Specifically, any point in the laser radar point set of the current frame can be selected as the laser radar data center point of the key frame; or, the laser radar data center point q₀ of the current frame can be determined according to the formula

$${q}_{0} = \frac{1}{N} {\sum }_{i = 1}^{N} {q}_{i} ;$$

where qᵢ is any point in the laser radar point set in the current frame; or, the laser radar center point in the current frame can be determined according to the geometric mean method, or the laser radar data center point in the current frame can also be determined according to the harmonic mean method.

S403, determining an initial estimated angle of the current frame according to the laser radar data center point of the key frame, the laser radar data center point of the current frame, the initial estimated position of the key frame, the initial estimated angle of the key frame and the initial estimated position of the current frame.

Specifically, the mobile robot determines a laser radar data center point of the key frame according to the laser radar point set of the key frame, and determines a laser radar data center point of the current frame according to the laser radar point set of the current frame, and determines an initial estimated angle of the current frame according to the laser radar data center point of the key frame, the laser radar data center point of the current frame, the initial estimated position of the key frame, the initial estimated angle of the key frame and the initial estimated position of the current frame.

Optionally, the initial estimated angle θ_{Fi} of the current frame can be determined according to the following formula:

θ₁=a tan 2(p₀ᵢ−p_{KFi})*y,(p₀ᵢ−p_{KFi})*x),

θ₂=a tan 2(p_{0F}−p_{Fi})*y,(p_{0F}−p_{Fi})*x),

θ_{Fi}=θ_{KFi}+(θ₂−θ₁),

where p₀ᵢ is the laser radar data center point of the key frame, p_{KFi} is the initial estimated position of the key frame, p_{0F} is the laser radar data center point of the current frame, p_{Fi} is the initial estimated position of the current frame, θ_{KFi} is the initial estimated angle of the key frame, a is a constant, x is the abscissa of the laser radar data point of the current frame, and y is the ordinate of the laser radar data point of the current frame.

In the mobile robot gyroscope data correction method provided by the above embodiment, the mobile robot determines a laser radar data center point of the key frame according to the laser radar point set of the key frame, and determines a laser radar data center point of the current frame according to the laser radar point set of the current frame, and then determines an initial estimated angle of the current frame according to the laser radar data center point of the key frame, the laser radar data center point of the current frame, the initial estimated position of the key frame, and the initial estimated position of the current frame. Since the laser radar data center point of the key frame and the laser radar data center point of the key frame are determined respectively through the laser radar point set of the key frame and the laser radar point set of the current frame, the laser radar data center point is representative and can reflect the overall trend of the laser radar point set of the key frame and the laser radar point set of the current frame, so as to make the determination of the initial estimated angle of the current frame more accurate.

S203, determining information of a candidate estimated pose of the current frame according to the initial estimated position of the current frame and the initial estimated angle of the current frame.

Specifically, the mobile robot, after using the ICP algorithm to determine the initial estimated position of the current frame and the initial estimated angle of the current frame according to the laser radar point set of the key frame, the laser radar point set of the current frame and the initial estimated position of the key frame, determines the information of candidate estimated poses of the current frame. Wherein, the information of candidate estimated poses includes the initial estimated position and the initial estimated angle of the current frame of the mobile robot.

Optionally, the initial estimated angle of the current frame can be determined by the formula pose_{Fi}=(P_{Fi},θ_{Fi}), wherein P_{Fi} is the initial estimated position of the current frame, θ_{Fi} is the initial estimated angle of the current frame, pose_{Fi} is the candidate estimated pose of the current frame.

The mobile robot gyroscope data correction method provided by the above embodiment, using the ICP algorithm, determines the initial estimated position of the key frame according to the laser radar point set of the key frame, the laser radar point set of the current frame and the initial estimated position of the key frame, and determines the initial estimated angle of the current frame according to the initial estimated angle of the key frame, the laser radar point set of the key frame, the laser radar point set of the current frame, the initial estimated position of the key frame, and the initial estimated position of the current frame, and determines information of a candidate estimated pose of the current frame according to the initial estimated position of the current frame and the initial estimated angle of the current frame. Due to the ICP algorithm, according to the laser radar point set of the key frame, the laser radar point set of the current frame and the initial estimated position of the key frame, the algorithm has fewer steps and low computational complexity, so it can quickly determine the initial estimated position and angle of the current frame, and then through the determined initial estimated position and angle of the current frame, it improves the speed of determining the estimated pose information of the current frame, which is convenient for correcting the gyroscope data more quickly.

FIG. 6 is a flow diagram of a mobile robot gyroscope data correction method provided by an embodiment. The present embodiment relates to a specific process for a mobile robot to determine a quantized value of each candidate estimated pose of the current frame according to the laser radar point set of the key frame and the laser radar point set of the current frame. Based on the above embodiment, as shown in FIG. 6, the implementation of step 103 may include S501, performing rotation translation transformation operation on Y laser radar point sets of the key frames to obtain Y transformed laser radar point sets.

Specifically, when performing the rotation translation transformation operation on the laser radar point set of each key frame, the laser radar point set of each key frame can be rotated first and then translated, or the laser radar point set of the key frame can be translated first and then rotated to obtain the transformed laser radar point set of each key frame In the same way, the rotation translation transformation operation is performed on the laser radar point sets of the Y key frames, so that Y transformed laser radar point sets are obtained.

Optionally, the corresponding rotation matrix R₀ and translation matrix t₀ can be obtained according to the embodiment method in FIG. 4, and the points in the key frame set can be rotated and translated by using the calculated R₀ and t₀, and the transformed laser radar point set P′ can be obtained by the following formula:

P′=R₀P+t₀,

where P is the laser radar point set of the key frame, R₀ is the rotation matrix, and t₀ is the translation matrix.

S502, determining a number of internal points and a number of external points in each of the transformed laser radar point sets according to each of the transformed laser radar point sets, the laser radar point set of the current frame and a first preset threshold.

For example, by comparing the distance between the data points in the transformed laser radar point set and the data points in the laser radar point set of the current frame with a first preset threshold, the number of internal points and external points in each transformed laser radar point set can be determined. The number of internal points and external points in different transformed laser radar point sets are different.

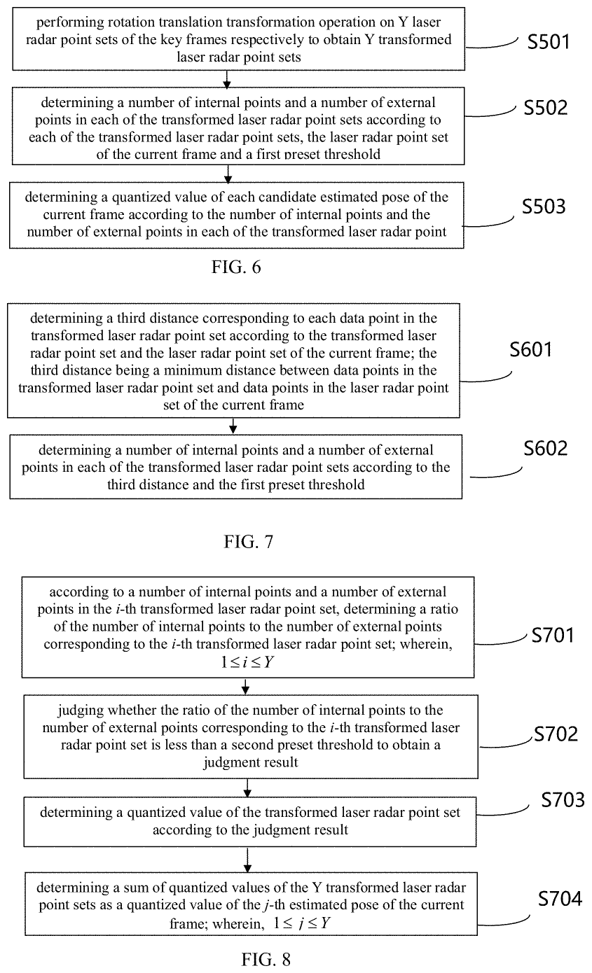

Optionally, as shown in FIG. 7, a possible implementation mode of S502 may include S601, determining a third distance corresponding to each data point in the transformed laser radar point set according to the transformed laser radar point set and the laser radar point set of the current frame; the third distance being a minimum distance between data points in the transformed laser radar point set and data points in the laser radar point set of the current frame.

Specifically, the mobile robot, after performing rotation translation transformation operation on the laser radar point set of the key frame to obtain the transformed laser radar point set, determines a minimum distance between each data point in the transformed laser radar point set and each data point in the laser radar point set of the current frame according to the transformed laser radar point set and the laser radar point set of the current frame; Optionally, first, any point in the transformed laser radar point set can be selected and the nearest data point in the laser radar point set of the current frame can be retrieved, and then the third distance between the point in the transformed laser radar point set and the retrieved data point in the laser radar point set of the current frame can be calculated.

For example, the third distance can be calculated by the following formula:

dᵢ=\sqrt{(x₁−x₂)²+(y₁−y₂)²},

where (x₁,y₁) are the point coordinates in the transformed laser radar point set, (x₂,y₂) are the point coordinates in the laser radar point set of the current frame, dᵢ is the third distance.

S602, determining a number of internal points and a number of external points in each of the transformed laser radar point sets according to the third distance and the first preset threshold.

Specifically, the first preset threshold is the threshold determined according to the actual situation. The mobile robot, after determining the third distance corresponding to each data point in the transformed laser radar point set according to the transformed laser radar point set and the laser radar point set of the current frame, compares the third distance with the first preset threshold, and determines the number of internal points and external points in each transformed laser radar point set according to the comparison result.

Optionally, if the third distance is less than the first preset threshold, the points in the transformed laser radar point set are determined as internal points; if the third distance is greater than three times of the first preset threshold, the points in the transformed laser radar point set are determined as external points; then, according to the internal points and external points in each transformed laser radar point set, the number of internal points and external points in each transformed laser radar point set are determined.

For example, the following formula can be used to determine the internal and external points in the transformed laser point set, traverse all the points in the transformed laser point set, and count the number of internal points num₁ and external points num₂ in the point set.

$${P}_{i}^{′} is \{ \begin{matrix}Internal point , & if {d}_{i} < ɛ \\ External point , & if {d}_{i} > 3 ɛ ,\end{matrix}$$

where Pᵢ′ is the transformed laser radar point set, dᵢ is the third distance, ands is the first preset threshold.

In the mobile robot gyroscope data correction method provided by the above amendment, the mobile robot, after performing rotation translation transformation operation on the laser radar point set of the key frame, obtains a transformed laser radar point set, and determines a third distance corresponding to each data point in the transformed laser radar point set and the data point in the nearest laser radar point set in the current frame according to the transformed laser radar point set and the laser radar point set of the current frame, and then determines a number of internal points and a number of external points in each transformed laser radar point set according to the size relationship between the third distance and the first preset threshold. Since the third distance being a minimum distance between data points in the transformed laser radar point set and data points in the laser radar point set of the current frame, the data points in the transformed laser radar point set are closer to the data points in the current frame laser radar point set, so as to determine the number of internal points and external points in the transformed laser radar point set more accurately.

S503, determining a quantized value of each candidate estimated pose of the current frame according to the number of internal points and the number of external points in each of the transformed laser radar point sets.

In the present embodiment, after determining the number of internal points and external points in the transformed laser radar point set, the quantized value of each estimated pose in the current frame can be determined according to the ratio of the number of internal points and external points.

Optionally, as shown in FIG. 8, a possible implementation mode of S503 may include S701, according to a number of internal points and a number of external points in the i-th transformed laser radar point set, determining a ratio of the number of internal points to the number of external points corresponding to the i-th transformed laser radar point set; wherein, 1≤i≤Y.

Specifically, after the mobile robot determines the number of internal points and external points in each transformed laser radar point set, and quotes the number of internal points and external points in the i-th transformed laser radar point set, the corresponding result is obtained, and the result is determined to be the ratio of the number of internal points and external points corresponding to the i-th transformed laser radar point set. For example, the ratio of the number of internal points to the number of external points

$$\frac{n u {m}_{1}}{n u {m}_{2}}$$

can be determined according to the number of internal points num₁ and the number of external points num₂ in the i-th transformed laser radar point set Pᵢ′.

S702, judging whether the ratio of the number of internal points to the number of external points corresponding to the i-th transformed laser radar point set is less than a second preset threshold to obtain a judgment result.

Specifically, the mobile robot, after determining the ratio of the number of internal points to the number of external points in the i-th transformed laser radar point set, and judging the size relationship between the ratio of the number of internal points and external points in the transformed laser radar point set and the second preset threshold, obtains the corresponding judgment result.

Optionally, the judgment result can be that the ratio of the number of internal points to the number of external points in the transformed laser radar point set is less than the second preset threshold, or the ratio of the number of interior points to the number of external points in the transformed laser radar point set is not less than the second preset threshold, that is, the ratio of the number of interior points to the number of external points in the transformed laser radar point set is greater than or equal to the second preset threshold.

S703, determining a quantized value of the transformed laser radar point set according to the judgment result.

Specifically, the mobile robot obtains a corresponding judgment result by determining whether the ratio of the number of internal points to the number of external points corresponding to the i-th transformed laser radar point set is less than the second preset threshold, and then determines the quantized value of the transformed laser radar point set according to the judgment result.

Optionally, if the judgment result is that the ratio of the number of internal points to the number of external points corresponding to the i-th transformed laser radar point set is less than the second preset threshold, then the ratio of the number of internal points to the number of external points corresponding to the i-th transformed laser radar point set is determined as the quantized value of the transformed laser radar point set; if the judgment result is that the ratio of the number of internal points to external points corresponding to the i-th transformed laser radar point set is not less than the second preset threshold, then the second preset threshold is determined to be the quantized value of the transformed laser radar point set.

For example, the judgment result can be determined by the following formula,

$$ICPscore ( {KF}_{i} , {F}_{j} , {pose}_{KFi} , {pose}_{Fj} ) = p ( \frac{{num}_{1}}{{num}_{2}} ) = \{ \begin{matrix}\frac{{num}_{1}}{{num}_{2}} , \frac{{num}_{1}}{{num}_{2}} < K \\ K , \frac{{num}_{1}}{{num}_{2}} \geq K\end{matrix}$$

where

$$\frac{n u {m}_{1}}{n u {m}_{2}}$$

is the ratio of the number of internal points and the number of external points in the transformed laser radar point set, K is the second preset threshold,

$$p ( \frac{n u {m}_{1}}{n u {m}_{2}} )$$

is the quantized value of the transformed laser radar point set, KFᵢ is the i-th transformed laser radar point set, Fⱼ is the laser radar point set of the current frame, pose_{KFi} is the i-th candidate estimated pose of the transformed laser radar point set, and pose_{Fj} is the j-th candidate estimated pose of the current frame.

S704, determining a sum of quantized values of the Y transformed laser radar point sets as a quantized value of a j-th estimated pose of the current frame; wherein, 1≤j≤Y.

Specifically, when the mobile robot determines the quantized value of the j-th candidate estimated pose of the current frame, it determines the ratio of the number of internal points and the number of external points in the i-th transformed laser radar point set, and judges whether the ratio is less than the second preset threshold, and then according to the judgment result, determines the quantized value of the i-th transformed laser radar point set, and then traverses the Y transformed laser radar point sets. At this time, the Y quantized values corresponding to the Y transformed laser radar point sets can be determined. The Y quantized values are accumulated and summed to obtain the corresponding result, which is determined as the quantized value of the j-th candidate estimated pose of the current frame.

For example, the quantized value of the j-th candidate estimated pose of the current frame may be determined by the following formula:

$${score}_{j} = {\sum }_{i = 0}^{Y} ICPscore ( {KF}_{i} , {F}_{j} , {pose}_{KFi} , {pose}_{Fj} ) ,$$

where KFᵢ is the i-th transformed laser radar point set, Fⱼ is the laser radar point set of the current frame, pose_{KFi} is the candidate estimated pose of the i-th transformed laser radar point set, pose_{Fj} is the j-th candidate estimated pose of the current frame, scoreⱼ is the quantized value of the j-th candidate estimated pose of the current frame, score(KFᵢ,Fⱼ, pose_{KFi},pose_{Fj}) is the quantized value of the i-th transformed laser radar point set corresponding to the j-th candidate estimated pose of the current frame.

It should be noted that the above process is the overall process of determining the quantized value of the j-th candidate estimated pose corresponding to the current frame. For each candidate estimated pose, Y key frames need to be traversed, and the sum of the quantized values of Y transformed laser radar point sets corresponding to the Y key frames is taken as the quantized value of the candidate estimated pose. By traversing each candidate estimated pose of the current frame, the Y quantized values corresponding to the Y estimated poses of the current frame can be determined. By comparing the Y quantized values of the current frame, the maximum quantized value of the current frame is obtained.

Optionally, if the maximum quantized value is greater than a third preset threshold, the gyroscope data of the mobile robot is corrected according to the candidate estimated pose information corresponding to the maximum quantized value.

Specifically, after the maximum quantized value of the current frame is determined, the maximum quantized value is compared with the third preset threshold. When the maximum quantized value is greater than the third preset threshold, the gyroscope data of the mobile robot is corrected according to the candidate estimated pose information corresponding to the maximum quantized value.

In the mobile robot gyroscope data correction method provided by the above embodiment, the mobile robot determines, according to the number of internal points and the number of external points in the i-th transformed laser radar point set, the ratio between the number of internal points and the number of external points corresponding to the i-th transformed laser radar point set, then judges whether the ratio is less than the second preset threshold to obtain the corresponding judgment result, and determines the quantized value of the i-th transformed laser radar point set according to the judgement result. The quantized values of the Y transformed laser radar point sets are obtained by traversing Y transformed laser radar point sets, and the sum of the Y quantized values is determined as the quantized value of the j-th candidate estimated pose. Then, the Y candidate estimated poses of the current frame are traversed to obtain the corresponding Y quantized values, and the maximum quantized value is determined therein. The maximum quantized value is compared with the third preset threshold. When the maximum quantized value is greater than the third preset threshold, the gyroscope is corrected according to the estimated pose information corresponding to the maximum quantized value. Since the mobile robot can better determine the relationship between the number of internal points and the number of external points by determining the ratio of the number of internal points to the number of external points in the transformed radar point set, and by comparing the ratio with the second preset threshold, so as to determine the quantized value of the i-th transformed laser radar point set more accurately, and add the quantized values of the Y transformed laser radar point sets, which makes the determination of the quantized value of the j-th estimated pose more accurate, which is convenient for more accurate correction of gyroscope data.

In the mobile robot gyroscope data correction method provided by the present embodiment, the mobile robot first performs rotation translation transformation operation on the laser radar point sets of Y key frames, obtains Y transformed laser radar point sets, and determines the number of internal points and the number of external points of each transformed laser radar point set according to each transformed laser radar point set, the laser radar point set of current frame and the first preset threshold. Then, according to the number of internal points and the number of external points in each transformed laser radar point set, the quantized value of each candidate estimated pose in the current frame is determined. According to the number of internal points and the number of external points in the transformed laser radar point set, the quantized value of each candidate estimated pose of the current frame can be accurately determined, which makes the mobile robot more accurate in determining the optimal pose of the current frame, thus greatly improving the accuracy of the gyroscope data correction and greatly improving the robustness of the system.

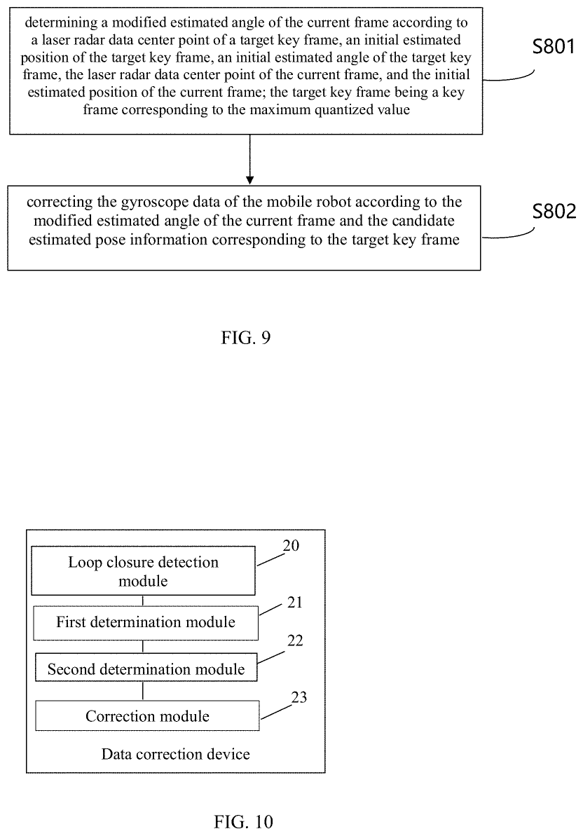

FIG. 9 is a flow diagram of a mobile robot gyroscope data correction method provided by an embodiment. This embodiment relates to the specific process of S104. On the basis of the above embodiment, as shown in FIG. 9, the method includes S801, determining a modified estimated angle of the current frame according to a laser radar data center point of a target key frame, an initial estimated position of the target key frame, an initial estimated angle of the target key frame, the laser radar data center point of the current frame, and the initial estimated position of the current frame; the target key frame being a key frame corresponding to the maximum quantized value.

Specifically, when the mobile robot corrects the gyroscope data according to the candidate estimated pose information in the key frame corresponding to the maximum quantized value, the modified estimated angle of the current frame can be further determined.

Optionally, the modified estimation angle of the current frame can be determined by the following formula,

θ₁=a tan 2(p₀ᵢ−p_{KFK})*y,(p₀ᵢ−P_{KFK})*x),

θ₂=a tan 2(p_{0F}−p_{FK})*y,(p_{0F}−p_{FK})*x),

θ_{FK}=θ_{KFK}+(θ₂−θ₁),

where p₀ᵢ is the data center point of the laser radar point set of the key frame, p_{KFK} is the initial estimated position of the key frame corresponding to the maximum quantized value, p_{0F} is the data center point of the laser radar point set of the current frame, p_{FK} is the initial estimated position of the current frame corresponding to the maximum quantized value, θ_{FK} is the initial estimated angle of the key frame corresponding to the maximum quantized value, θ_{KFK} is the modified estimated angle of the current frame, a is a constant, x is the abscissa of the current frame laser radar data point, and y is the ordinate of the current frame laser radar data point.

S802, correcting the gyroscope data of the mobile robot according to the modified estimated angle of the current frame and the candidate estimated pose information corresponding to the target key frame.

Specifically, after the mobile robot determines the modified estimated angle of the current frame, and then according to the modified estimated angle of the current frame and the estimated pose information of the key frame corresponding to the maximum quantized value, the mobile robot can further correct the gyroscope data, thus further improving the accuracy of the gyroscope correction.

In the mobile robot gyroscope data correction method provided by the present embodiment, the mobile robot first determines the modified estimated angle of the current frame according to the laser radar data center point of the key frame corresponding to the maximum quantized value, the initial estimated position of the key frame, the initial estimated angle of the key frame, the laser radar data center point of the current frame, and the initial estimated position of the current frame, and according to the modified estimated angle of the current frame and the candidate estimated pose information corresponding to the key frame, the gyroscope data of the mobile robot is corrected. The accuracy of gyroscope data correction is further improved by determining the modified estimated angle the current frame.

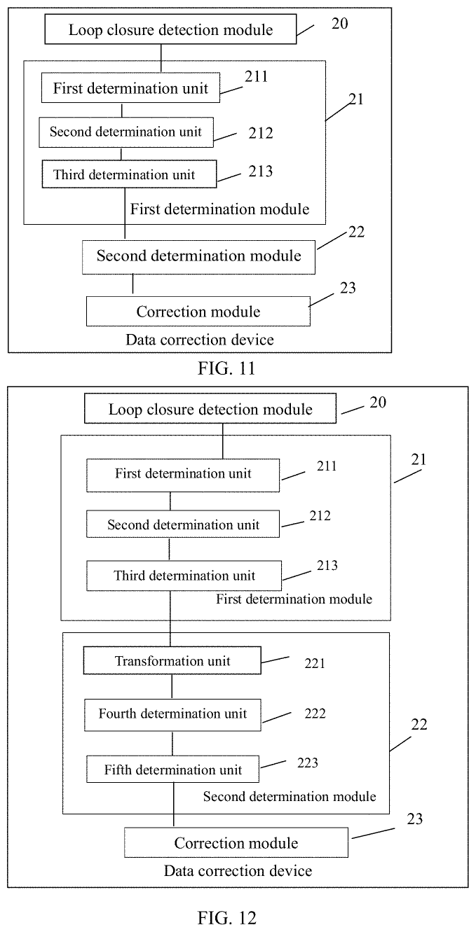

FIG. 10 is a schematic diagram of a mobile robot gyroscope data correction device provided by an embodiment. As shown in FIG. 10, the device includes: a loop closure detection module 20, a first determination module 21, a second determination module 22, and a first correction module 23.

The loop closure detection module 20 is used to perform loop closure detection of laser radar data in a current frame.

The first determination module 21 is used to, when the loop closure detection is successful, use an iterative closest point ICP algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot. The second determination module 22 is used to determine a quantized value of each candidate estimated pose of the current frame according to the laser radar point set of each key frame and the laser radar point set of the current frame.

The first correction module 23 is used to correct the gyroscope data of the mobile robot according to the candidate estimated pose information corresponding to the maximum quantized value among the Y quantized values.

The mobile robot gyroscope data correction device provided by the present embodiment can implement the method embodiment shown in FIG. 2, and its implementation principle and technical effect are similar, so it will not be repeated here.

FIG. 11 is a schematic diagram of a mobile robot gyroscope data correction device provided by another embodiment. As shown in FIG. 11, on the basis of the embodiment shown in FIG. 10, the first determination module 21 includes: a first determination unit 211, a second determination unit 212, and a third determination unit 213.

Specifically, the first determination unit 211 is used to determine the initial estimated position of the current frame according to the laser radar point set of the key frame, the laser radar point set of the current frame and the initial estimated position of the key frame using the ICP algorithm.

The second determination unit 212 is used for determining the initial estimated angle of the current frame according to the laser radar point set of the key frame, the laser radar point set of the current frame, the initial estimated position of the key frame, the initial estimated angle of the key frame and the initial estimated position of the current frame.

The third determination unit 213 is used for determining the candidate estimated pose information of the current frame according to the initial estimated position of the current frame and the initial estimated angle of the current frame.

The mobile robot gyroscope data correction device provided by the present embodiment can implement the method embodiment shown in FIG. 3, and its implementation principle and technical effect are similar, so it will not be repeated here.

In one of the embodiments, optionally, the first determination unit 211 is specifically used to determine the estimated matrix according to the laser radar point set of the key frame and the laser radar point set of the current frame by using the ICP algorithm; the estimated matrix includes a rotation matrix and a translation matrix; the initial estimated position of the current frame is determined according to the estimated matrix and the initial estimated position of the key frame.

In one of the embodiments, optionally, the second determination unit 212 is specifically used to determine the laser radar data center point of the key frame according to the laser radar point set of the key frame; determine the laser radar data center point of the current frame according to the laser radar point set of the current frame; determine the initial estimated angle of the current frame according to the laser radar data center point of the key frame, the laser radar data center point of the current frame, the initial estimated position of the key frame, the initial estimated angle of the key frame and the initial estimated position of the current frame.

In one embodiment, optionally, the second determination unit 212 is specifically used to determine the laser radar data center point p₀ in the key frame according to the formula

$${p}_{0} = \frac{1}{N} {\sum }_{i = 1}^{N} {P}_{i} ;$$

where pᵢ is any point in the laser radar point set in the key frame; determine the laser radar data center point q₀ in the current frame according to the formula

$${q}_{0} = \frac{1}{N} {\sum }_{i = 1}^{N} {q}_{i} ;$$

where qᵢ is any point in the laser radar point set in the current frame.

FIG. 12 is a schematic diagram of a mobile robot gyroscope data correction device provided by another embodiment. As shown in FIG. 12, on the basis of the embodiment shown in FIG. 11, the second determination module 22 includes a transformation unit 221, a fourth determination unit 222, and a fifth determination unit 223.

Specifically, the transformation unit 221 is used to perform rotation translation transformation on Y laser radar point sets of the key frames, and obtain Y transformed laser radar point sets.

The fourth determination unit 222 is used to determine the number of internal points and the number of external points in each of the transformed laser radar point sets according to each of the transformed laser radar point sets, the laser radar point set of the current frame, and the first preset threshold.

The fifth determination unit 223 is used to determine the quantized value of each candidate estimated pose of the current frame according to the number of internal points and the number of external points in each of the transformed laser radar point sets.

The mobile robot gyroscope data correction device provided by the present embodiment can implement the method embodiment shown in FIG. 6, and its implementation principle and technical effect are similar, so it will not be repeated here.

In one of the embodiments, optionally, the fourth determination unit 222 is specifically used to determine the third distance corresponding to each data point in the transformed laser radar point set according to the transformed laser radar point set and the laser radar point set of the current frame; the third distance is the minimum distance between data points in the transformed laser radar point set and data points in the laser radar point set of the current frame; determine the number of internal points and the number of external points in each of the transformed laser radar point sets according to the third distance and the first preset threshold.

In one of the embodiments, optionally, the fourth determination unit 222 is specifically used to determine, if the third distance is less than the first preset threshold, determine that points in the transformed laser radar point set to be internal points; if the third distance is greater than three times of the first preset threshold, determine that points in the transformed laser radar point set to be external points; determine the number of internal points and the number of external points in each of the transformed laser radar point sets according to the internal points and external points in each of the transformed laser radar point sets.

The mobile robot gyroscope data correction device provided by the present embodiment can implement the method embodiment shown in FIG. 7, and its implementation principle and technical effect are similar, so it will not be repeated here.

In one of the embodiments, optionally, the fifth determination unit 223 is specifically used to determine, according to the number of internal points and the number of external points in the i-th transformed laser radar point set, the ratio of the number of internal points to the number of external points corresponding to the i-th transformed laser radar point set; wherein, 1≤i≤Y; judge whether the ratio of the number of internal points to the number of external points corresponding to the i-th transformed laser radar point set is less than the second preset threshold to obtain the judgment result; determine a quantized value of the transformed laser radar point set according to the judgment result; determine the sum of quantized values of the Y transformed laser radar point sets as the quantized value of the j-th estimated pose of the current frame; wherein, 1≤j≤Y.

In one of the embodiments, optionally, the fifth determination unit 223 is specifically used to determine, if the judgment result is that the ratio of the number of internal points to the number of external points corresponding to the i-th transformed laser radar point set is less than the second preset threshold, the ratio of the number of internal points to the external points corresponding to the i-th transformed laser radar point set as the quantized value of the transformed laser radar point set; if the judgment result is that the ratio of the number of internal points to the number of external points corresponding to the i-th transformed laser radar point set is not less than the second preset threshold, determine the second preset threshold as the quantized value of the transformed laser radar point set.

In one of the embodiments, optionally, the correction module 23 is specifically used to, if the maximum quantized value is greater than a third preset threshold, correct the gyroscope data according to the candidate estimated pose information corresponding to the maximum quantized value.

The mobile robot gyroscope data correction device provided by the present embodiment can implement the method embodiment shown in FIG. 8, and its implementation principle and technical effect are similar, so it will not be repeated here.

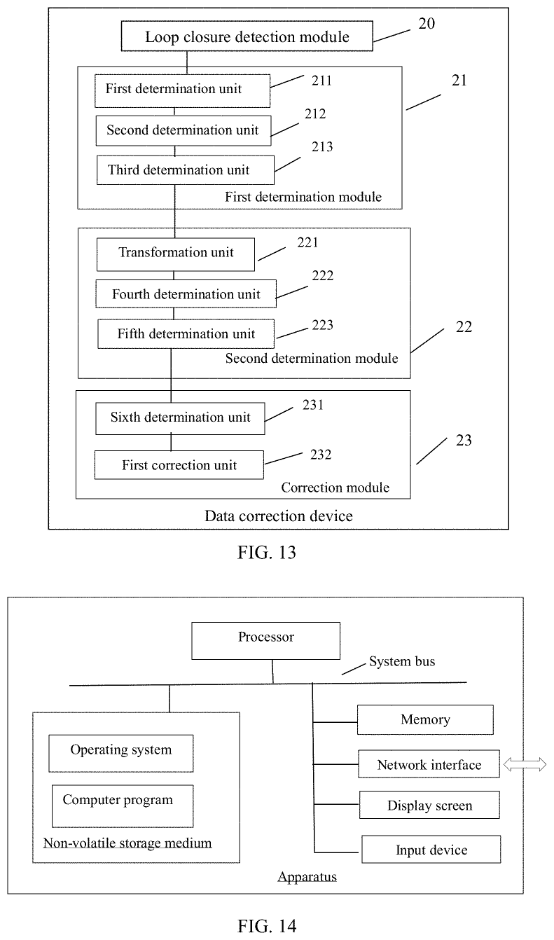

FIG. 13 is a schematic diagram of a mobile robot gyroscope data correction device provided by another embodiment. As shown in FIG. 13, on the basis of the above embodiment, the correction module 23 includes: a sixth determination unit 231, and a first correction unit 232.

Specifically, the sixth determination unit 231 is used to determine the modified estimated angle of the current frame according to the laser radar data center point of the target key frame, the initial estimated position of the target key frame, the initial estimated angle of the target key frame, the laser radar data center point of the current frame, and the initial estimated position of the current frame; the target key frame is the key frame corresponding to the maximum quantized value.

The first correction unit 232 is used to correct the gyroscope data of the mobile robot according to the modified estimated angle of the current frame and the candidate estimated pose information corresponding to the target key frame.

The mobile robot gyroscope data correction device provided by the present embodiment can implement the method embodiment shown in FIG. 9, and its implementation principle and technical effect are similar, so it will not be repeated here.

For the specific limitations of the device for controlling the data correction, please refer to the limitations of the above data correction method in the above text, and it will not be repeated here. Each module of the data correction device can be realized wholly or partly by software, hardware and their combination. The above modules can be embedded in the form of software in or independent of the processor of the robot, or stored in the form of software in the memory of the robot, so as to facilitate the processor to call and perform the corresponding operations of the above modules.

In one embodiment, an apparatus is provided, and its internal structure diagram can be as shown in FIG. 14. The robot may include a processor, a memory, a network interface, a display screen and an input device connected via a system bus. The processor of the robot is used to provide computing and control capabilities. The memory of the robot includes non-volatile storage medium and memory. The non-volatile storage medium stores the operating system and computer program. The memory provides an environment for operating system and computer program running in the non-volatile storage medium. The network interface of the robot is used to communicate with external terminals through a network connection. The computer program is executed by the processor to realize a data correction method. The display screen of the robot can be a liquid crystal display or an electronic ink display screen, and the input device of the robot can be a touch layer covered on the display screen, buttons, a track ball or a touch control board set on the shell of the robot, or an external keyboard, touch control board or mouse, etc.

It can be understood by those skilled in the art that the structure shown in FIG. 14 is only a block diagram of a part of the structure related to the application scheme, and does not constitute a limitation on the robot applied to the solution of the present application. The specific robot may include more or fewer components than shown in the figure, or combine some components, or have different component arrangements.

In one embodiment, an apparatus is provided, including a memory and a processor, a computer program being stored in the memory, and the processor realizes the following steps when executing the computer program: performing loop closure detection of laser radar data of a current frame; if the loop closure detection is successful, using an iterative closest point (ICP) algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot; determining a quantized value of each candidate estimated pose of the current frame according to the laser radar point set of each key frame and the laser radar point set of the current frame; correcting the gyroscope data of the mobile robot according to the candidate estimated pose information corresponding to the maximum quantized value among the Y quantized values.

In one embodiment, a computer-readable storage medium is provided, including a computer program; when the computer program is executed by the processor, the computer program is configured to realize the following steps: performing loop closure detection of laser radar data of a current frame; if the loop closure detection is successful, using an iterative closest point (ICP) algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot; determining a quantized value of each candidate estimated pose of the current frame according to the laser radar point set of each key frame and the laser radar point set of the current frame; correcting the gyroscope data of the mobile robot according to the candidate estimated pose information corresponding to the maximum quantized value among the Y quantized values.

A person of ordinary skill in the art can understand that all or part of the flow in implementing the above embodiment methods can be completed by instructing relevant hardware through a computer program. The computer program can be stored in a non-volatile computer readable storage medium, and when executed, the computer program may include the flow of the embodiments of the above methods. Any reference to a memory, a storage, a database or any other media used in the embodiments provided by the present application may include a non-volatile and/or a volatile memory. A non-volatile memory may include a read-only memory (ROM), a programmable ROM (PROM), an electrically programmable ROM (EPROM), an electrically erasable programmable ROM (EEPROM), or a flash memory. A volatile memory may include a random-access memory (RAM) or an external cache memory. As an illustration rather than a limitation, a RAM is available in various forms, such as a static RAM (SRAM), a dynamic RAM (DRAM), a synchronous DRAM (SDRAM), a dual data rate SDRAM (DDRSDRAM), an enhanced SDRAM (ESDRAM), a synchronous link (Synchlink) DRAM (SLDRAM), a Rambus direct RAM (RDRAM), a direct Rambus dynamic RAM (DRDRAM), and a Rambus dynamic RAM (RDRAM), etc.

The technical features of the above embodiments can be arbitrarily combined. In order to make the description concise, not all possible combinations of the above-mentioned technical features are described. However, as long as the combination of these technical features is not contradictory, it should be considered as the scope of the description.

The above-mentioned embodiments only express several embodiments of the present disclosure, and the description is more specific and detailed, but it can not be understood as a limitation on the patent scope of the present disclosure. It should be pointed out that for an ordinary technical person in the art, certain deformations and improvements can be made without departing from the concept of the present disclosure, which belong to the protection scope of the present disclosure. Therefore, the patent protection scope of the present disclosure shall be on the basis of the attached claims.

What is claimed is:

1. A mobile robot gyroscope data correction method, comprising:
obtaining laser radar data of a current frame, wherein a loop closure detection of the laser radar data of the current frame is successful;
using an iterative closest point (ICP) algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot;
determining a quantized value of each of the Y candidate estimated poses of the current frame according to the laser radar point set of each of the Y key frames and the laser radar point set of the current frame, wherein there is a maximum quantized value among the Y quantized values; and
correcting the gyroscope data of the mobile robot according to the candidate estimated pose information corresponding to the maximum quantized value among the Y quantized values.

2. The method of claim 1, wherein using the ICP algorithm to determine the information of Y candidate estimated poses of the current frame further comprises:
using the ICP algorithm to determine an initial estimated position of the current frame according to the laser radar point set of the key frames, the laser radar point set of the current frame and the initial estimated position of the key frames;
determining an initial estimated angle of the current frame according to the laser radar point set of the key frames, the laser radar point set of the current frame, the initial estimated position of the key frames, the initial estimated angle of the key frames and the initial estimated position of the current frame; and
determining information of a candidate estimated pose of the current frame according to the initial estimated position of the current frame and the initial estimated angle of the current frame.

3. The method of claim 2, wherein using the ICP algorithm to determine the initial estimated position of the current frame further comprises:
using the ICP algorithm to determine an estimated matrix according to the laser radar point set of the key frames and the laser radar point set of the current frame, wherein the estimated matrix including a rotation matrix and a translation matrix; and
determining an initial estimated position of the current frame according to the estimated matrix and the initial estimated position of the key frames.

4. The method of claim 2, wherein determining the initial estimated angle of the current frame further comprises:
determining a laser radar data center point of the key frame according to the laser radar point set of the key frames;
determining a laser radar data center point of the current frame according to the laser radar point set of the current frame; and
determining an initial estimated angle of the current frame according to the laser radar data center point of the key frame, the laser radar data center point of the current frame, the initial estimated position of the key frames, the initial estimated angle of the key frames and the initial estimated position of the current frame.

5. The method of claim 4, wherein determining the laser radar data center point of the key frame further comprises determining a laser radar data center points p₀ in the key frame according to a formula
$${p}_{0} = \frac{1}{N} {\sum }_{i = 1}^{N} {P}_{i} ,$$
where pᵢ is any point in the laser radar point set of the key frame.

6. The method of claim 4, wherein determining the laser radar data center point of the current frame further comprises determining a laser radar data center points q₀ in the current frame according to a formula
$${q}_{0} = \frac{1}{N} {\sum }_{i = 1}^{N} {q}_{i} ,$$
where qᵢ is any point in the laser radar point set of the current frame.

7. The method of claim 1, wherein determining the quantized value of each of the Y candidate estimated poses of the current frame further comprises:
performing rotation translation transformation operation on Y laser radar point sets of the key frames to obtain Y transformed laser radar point sets;
determining a plurality of internal points and external points, and the number of internal points and the number of external points in each of the transformed laser radar point sets according to each of the transformed laser radar point sets, the laser radar point set of the current frame and a first preset threshold, wherein a point is an internal point when a third distance is less than a first preset threshold and a point is an external point when the third distance is greater than three times of the first preset threshold; and
determining a quantized value of each candidate estimated pose of the current frame according to the number of internal points and the number of external points in each of the transformed laser radar point sets,
wherein the third distance is a minimum distance between data points in the transformed laser radar point set and data points in the laser radar point set of the current frame.

8. The method of claim 7, wherein determining the quantized value of each candidate estimated pose of the current frame further comprises:
determining a ratio of the number of internal points to the number of external points of the i-th transformed laser radar point set, wherein 1≤i≤Y;
determining a quantized value of each of the transformed laser radar point sets by comparing the ratio of the number of internal points to the number of external points corresponding to the i-th transformed laser radar point set with a second preset threshold; and
setting a sum of quantized values of the Y transformed laser radar point sets as a quantized value of the j-th estimated pose of the current frame; wherein, 1≤j≤Y.

9. The method of claim 8, wherein:
the ratio of the number of internal points to the external points corresponding to the i-th transformed laser radar point set is determined as the quantized value of the i-th transformed laser radar point set when the ratio of the number of internal points to the number of external points corresponding to the i-th transformed laser radar point set is less than the second preset threshold; and
the second preset threshold is determined as the quantized value of the i-th transformed laser radar point set when the ratio of the number of internal points to the number of external points corresponding to the i-th transformed laser radar point set is not less than the second preset threshold.

10. The method of claim 9, wherein correcting the gyroscope data of the mobile robot further comprises correcting the gyroscope data of the mobile robot according to the candidate estimated pose information corresponding to the maximum quantized value when the maximum quantized value is greater than a third preset threshold.

11. The method of claim 10, further comprising:
determining a modified estimated angle of the current frame according to a laser radar data center point of a target key frame, an initial estimated position of the target key frame, an initial estimated angle of the target key frame, the laser radar data center point of the current frame, and the initial estimated position of the current frame, wherein the target key frame is the key frame with the maximum quantized value; and
correcting the gyroscope data of the mobile robot according to the modified estimated angle of the current frame and the candidate estimated pose information corresponding to the target key frame.

12. A device for mobile robot gyroscope data correction, comprising:
a loop closure detection module configured to perform loop closure detection of laser radar data in a current frame;
a first determination module configured to determine information of Y candidate estimated poses of the current frame by an iterative closest point (ICP) algorithm according to initial estimated positions of Y key frames of the mobile robot, laser radar point sets of the Y key frames, initial estimated angles of the Y key frames, and a laser radar point set of the current frame of the mobile robot;
a second determination module configured to determine a quantized value of each candidate estimated pose of the current frame according to the laser radar point set of each key frame and the laser radar point set of the current frame, wherein there is a maximum quantized value among the Y quantized values; and
a correction module configured to correct the gyroscope data of the mobile robot according to the candidate estimated pose information corresponding to the maximum quantized value among the Y quantized values.

13. The device of claim 12, wherein the first determination module further comprises:
a first determination unit configured to determine an initial estimated position of the current frame according to the laser radar point set of the key frame, the laser radar point set of the current frame and the initial estimated position of the key frame using the ICP algorithm;
a second determination unit configured to determine an initial estimated angle of the current frame according to the laser radar point set of the key frame, the laser radar point set of the current frame, the initial estimated position of the key frame, the initial estimated angle of the key frame and the initial estimated position of the current frame; and
a third determination unit configured to determine the candidate estimated pose information of the current frame according to the initial estimated position of the current frame and the initial estimated angle of the current frame.

14. The device of claim 13, wherein the first determination unit is further configured to:
use the ICP algorithm to determine an estimated matrix according to the laser radar point set of the key frames and the laser radar point set of the current frame, wherein the estimated matrix including a rotation matrix and a translation matrix; and
determine an initial estimated position of the current frame according to the estimated matrix and the initial estimated position of the key frames.

15. The device of claim 14, wherein the second determination unit is further configured to:
determine a laser radar data center point of the key frame according to the laser radar point set of the key frames;
determine a laser radar data center point of the current frame according to the laser radar point set of the current frame; and
determine an initial estimated angle of the current frame according to the laser radar data center point of the key frame, the laser radar data center point of the current frame, the initial estimated position of the key frames, the initial estimated angle of the key frames and the initial estimated position of the current frame.

16. The device of claim 13, wherein the second determination module further comprises:
a transformation unit configured to perform rotation translation transformation on Y laser radar point sets of the key frames, and obtain Y transformed laser radar point sets;
a fourth determination unit configured to determine a plurality of internal points and a plurality of external points, and the number of internal points and the number of external points in each of the transformed laser radar point sets according to each of the transformed laser radar point sets, the laser radar point set of the current frame, and the first preset threshold, wherein a point is an internal point when a third distance is less than a first preset threshold and a point is an external point when the third distance is greater than three times of the first preset threshold; and
a fifth determination unit configured to determine the quantized value of each candidate estimated pose of the current frame according to the number of internal points and the number of external points in each of the transformed laser radar point sets,
wherein the third distance is a minimum distance between data points in the transformed laser radar point set and data points in the laser radar point set of the current frame

17. The device of claim 16, wherein the correction module further comprises:
a sixth determination unit configured to determine a modified estimated angle of the current frame according to a laser radar data center point of a target key frame, an initial estimated position of the target key frame, an initial estimated angle of the target key frame, the laser radar data center point of the current frame, and the initial estimated position of the current frame, wherein the target key frame is the key frame corresponding to the maximum quantized value; and
a first correction unit configured to correct gyroscope data of the mobile robot according to the modified estimated angle of the current frame and the candidate estimated pose information corresponding to the target key frame.

18. An apparatus, comprising a processor and a memory, wherein when the processor runs a computer program stored on the memory, the steps realized by the processor comprises:
obtaining laser radar data of a current frame, wherein a loop closure detection of the laser radar data of the current frame is successful;
using an iterative closest point (ICP) algorithm to determine information of Y candidate estimated poses of the current frame according to initial estimated positions of Y key frames of the mobile robot, laser radar point sets of the Y key frames, initial estimated angles of the Y key frames, and a laser radar point set of the current frame of the mobile robot;
determining a quantized value of each of the Y candidate estimated poses of the current frame according to the laser radar point set of each of the Y key frames and the laser radar point set of the current frame, wherein there is a maximum quantized value among the Y quantized values; and
correcting the gyroscope data of the mobile robot according to the candidate estimated pose information corresponding to the maximum quantized value among the Y quantized values.

19. The apparatus of claim 18, wherein using the ICP algorithm to determine information of Y candidate estimated poses of the current frame further comprises:
using the ICP algorithm to determine an initial estimated position of the current frame according to the laser radar point set of the key frames, the laser radar point set of the current frame and the initial estimated position of the key frames;
determining an initial estimated angle of the current frame according to the laser radar point set of the key frames, the laser radar point set of the current frame, the initial estimated position of the key frames, the initial estimated angle of the key frames and the initial estimated position of the current frame; and
determining information of a candidate estimated pose of the current frame according to the initial estimated position of the current frame and the initial estimated angle of the current frame.

20. The apparatus of claim 18, wherein determining the quantized value of each of the Y candidate estimated poses of the current frame further comprises:
performing rotation translation transformation operation on Y laser radar point sets of the key frames to obtain Y transformed laser radar point sets;
determining a plurality of internal points and external points, and the number of internal points and the number of external points in each of the transformed laser radar point sets according to each of the transformed laser radar point sets, the laser radar point set of the current frame and a first preset threshold, wherein a point is an internal point when a third distance is less than a first preset threshold and a point is an external point when the third distance is greater than three times of the first preset threshold; and
determining a quantized value of each candidate estimated pose of the current frame according to the number of internal points and the number of external points in each of the transformed laser radar point sets,
wherein the third distance is a minimum distance between data points in the transformed laser radar point set and data points in the laser radar point set of the current frame.
